(19) United States
(12) Patent Application Publication
(10) Pub. No.: US 2012/0058455 A1
(43) Pub. Date: Mar. 8, 2012

(54) Device and Method for Facilitating Conversation

(75) Inventors: Richard Allen Lawrence, Centennial, CO (US); Amy L. W. Nappa, Loveland, CO (US); Joan Louise Schultz, Loveland, CO (US); Jeffrey Scott White, Loveland, CO (US); Christine C. Yount Jones, Loveland, CO (US)

(73) Assignee: GROUP PUBLISHING, INC., Loveland, CO (US)

(21) Appl. No.: 12/874,382

(22) Filed: Sep. 2, 2010

(51) Int. Cl. G09B 21/00

(52) U.S. Cl. 434/112

(57) ABSTRACT

A system and method for facilitating conversation. In particular, the system discloses a handheld device suitable for use in engaging conversation. The device includes a data store for storing a plurality of conversation starters. The plurality of conversation starters is associated with a theme. The device includes a selector that is associated with a subset of the plurality of conversation starters. The subset defines a category of conversation starters consistent with the theme. The device includes a processor configured to receive and acknowledge activation of the selector. Upon activation, the processor selects a conversation starter of the subset of the plurality of conversation starters, as a selected conversation starter. A communicator, such as a speaker, is included for presenting the selected conversation starter.

### BACKGROUND OF THE INVENTION

1. Field of Invention

The present invention relates to educational activities. Specifically, the present invention relates to a portable device designed to facilitate conversation between persons in any environment, and in particular to facilitate conversation through the use of conversation starters designed to pass along family values.

2. The Relevant Technology

There are many influences on a child. To name a few, family, friends, neighbors, school, media, and social media all come in and out of a child's life. Those influences, either good, bad, or neutral, may have a significant impact on how that child matures and sees himself or herself within the world.

Importantly, a constant influence on a child is the parent or caretaker, collectively referred to as “parent.” The relationship formed between the parent and the child helps to form how that child matures. If done with persistence, that relationship forms a conduit through which a parent can teach and convey his or her family values to the child. In many ways, that relationship is formed through personal interactions between the parent and the child.

However, the daily pressures of modern life can reduce the number and quality of daily interactions between a parent and child, thereby working against the passing along of family values. For instance, a parent may be more involved with work, to include working longer hours coupled with longer commutes, than at any period in history. In addition, the child may be participating in various organized activities, such as school, sports, arts (e.g., music theater, singing, etc.). All of this leads to less and less formative interactions between a parent and a child. For instance, the family dinner, once a common activity suitable for holding contemplative discussions, is now giving way to snatching and grabbing whatever food you can on the way to the next activity.

In most cases, the parent desires to convey his or her values (e.g., ideas, thoughts, family values, etc.) onto the child whatever time, work, and other constraints may exist. However, parents may feel under qualified to try and teach those values to the child, and fail to make any concerted effort to convey those values. For instance, faith may be an important part of a parent's life, and one that he or she wants to convey to the child. But the parent may not have the confidence to discuss faith-based topics with the child thinking that years of study (e.g., being a Bible scholar) are necessary to be competent to lead a discussion with the child. As a result, the parent becomes reluctant to hold any discussion relating to his or her faith-based values. In these cases, the parent is missing the point, as any parent would be well qualified to pass on his or her faith-based values, whatever they may be, to his or her child.

The lack of time and/or self confidence reduces many interactions between a parent and child to a utilitarian purpose. For instance, discussions focus on tasks to be performed at school, how practice went for a particular sport, who is taking out the garbage or cleaning the dishes, instructions to clean up a room, etc. None of these topics lead to a discussion on values to be passed on to a child.

### SUMMARY OF THE INVENTION

A system and method for facilitating conversation. In particular, the system discloses a handheld device suitable for use in engaging conversation, such as faith-based conversation, in accordance with one embodiment of the present invention. The device includes a data store for storing a plurality of conversation starters. The plurality of conversation starters is associated with a theme. For instance, one theme is a family faith edition, where the conversation starters are designed to facilitate faith-based conversation. The device includes a selector that is associated with a subset of the plurality of conversation starters. The subset defines a category of conversation starters consistent with the theme. As such, conversation starters are related as being consistent with the category, separate and distinct from other conversation starters belonging to other categories. The device also includes a processor configured to receive and acknowledge activation of the selector. Upon activation of the selector, the processor selects a conversation starter of the subset of the plurality of conversation starters, as a selected conversation starter. A communicator is included for presenting the selected conversation starter. For instance, the communicator is a speaker for presenting the selected conversation starter in audio form.

In another embodiment, a method for facilitating conversation is disclosed. The method includes providing a plurality of conversation starters in a data store. Activation of a selector is received, for instance by a processor. The selector is associated with a subset of the plurality of conversation starters. For instance, the conversation starters in the subset are grouped under a common category, separate and distinct from other conversation starters belonging to other categories. One of the subset of the plurality of conversation starters is selected, as a selected conversation starter, upon activation of the selector. The conversation starter is presented, such as through a speaker in audio form, or through a display in text form.

### BRIEF DESCRIPTION OF THE DRAWINGS

Exemplary embodiments are illustrated in referenced figures of the drawings which illustrate what is regarded as the preferred embodiments presently contemplated. It is intended that the embodiments and figures disclosed herein are to be considered illustrative rather than limiting.

FIG. 1 is a flow diagram illustrating a method of facilitating conversation, in accordance with one embodiment of the present invention.

FIG. 2 is an illustration of a portable system for facilitating conversation, in accordance with one embodiment of the present invention.

FIG. 3 is an illustration of a portable system for facilitating conversation that includes a speaker for broadcasting conversation starters used to facilitate conversation, in accordance with one embodiment of the present invention.

FIG. 4 is an illustration of a portable system for facilitating conversation capable of appropriating one or more themes of conversation starters, wherein each theme includes one or more categories of conversation starters, and wherein each category of conversation starters is applicable across multiple themes, in accordance with one embodiment of the present invention.

FIG. 5A is an illustration of the sequential selection of a conversation starter from a plurality of conversation starters that is sequentially ordered, in accordance with one embodiment of the present invention.

FIG. 5B is an illustration of the random selection of a conversation starter from a selectable group of conversation starters, in accordance with one embodiment of the present invention.

### DETAILED DESCRIPTION OF THE PREFERRED EMBODIMENTS

Reference will now be made in detail to the preferred embodiments of the present invention, a system and method for facilitating conversation, such as between a parent and child for purposes of conveying values held by the parent to the child. While the invention will be described in conjunction with the preferred embodiments, it will be understood that they are not intended to limit the invention to these embodiments. On the contrary, the invention is intended to cover alternatives, modifications and equivalents which may be included within the spirit and scope of the invention as defined by the appended claims.

Accordingly, embodiments of the present invention provide for a system and method for facilitating conversation. Embodiments of the present invention provide for a device that is portable so that a user is able to engage the device upon short notice in order to facilitate a conversation, such as between a parent and child, for purposes of conveying values held by the parent to the child. Other embodiments of the present invention provide the above advantages, and further provide for a convenient way to facilitate conversation, since through only one interaction with the device a conversation starter is presented. Still other embodiments of the present invention provide the above advantages, and further provide for a way to facilitate conversation without reading text, such that that the device may be used to facilitate conversation in the dark.

### 1. Notation and Nomenclature

Embodiments of the present invention can be implemented on software running on a dedicated device or computer system, hardware implementing dedicated functionality on a dedicated device or computer system, or a combination of both. The dedicated device is a system that functions mainly to facilitate conversation. The more general purpose computer system can be a personal computer, notebook computer, server computer, mainframe, networked computer, handheld computer, personal digital assistant, workstation, mobile phone, multi-functional mobile device, and the like. In one embodiment, the dedicated device and/or computer system includes a processor coupled to a bus and memory storage coupled to the bus. The memory storage can be volatile or non-volatile and can include removable storage media. The dedicated device and/or computer system can also include a display, provision for data input and output, etc.

Some portions of the detailed descriptions that follow are presented in terms of procedures, steps, logic block, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc. is here, and generally, conceived to be a self-consistent sequence of operations or instructions leading to a desired result. The operations are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “receiving,” “providing,” “selecting,” or the like refer to the actions and processes of a computer system, or similar electronic computing device, including an embedded system, that manipulates and transfers data represented as physical (electronic) quantities within the computer system's registers and memories into other data similarly represented as physical quantities within the computer system memories or registers or other such information storage, transmission or display devices.

Although the methods and systems are described throughout this Application in embodiments as facilitating conversation between a parent and a child for purposes of conveying values held by the parent to the child, it should be appreciated that the methods and systems are intended to facilitate conversation between any two or more persons for any purpose. That is, the parent may be a caretaker for the child, or someone of influence (e.g., teacher or instructor) over the child. Also, the relationship between the two or more persons may be varied, in that the relationship may be a caretaker to cared relationship where one where one is caring for the other, or a teacher to student relationship where one is providing knowledge to the other, or a peer to peer relationship where two peers are discussing a topic, to list a few. In addition, there may be no relationship, in that the device and method are implemented to facilitate contemplative thought or stimulate thought for a single user, or multiple users, instead of initiating a conversation between individuals.

2. Conveying Values through Conversation Starters

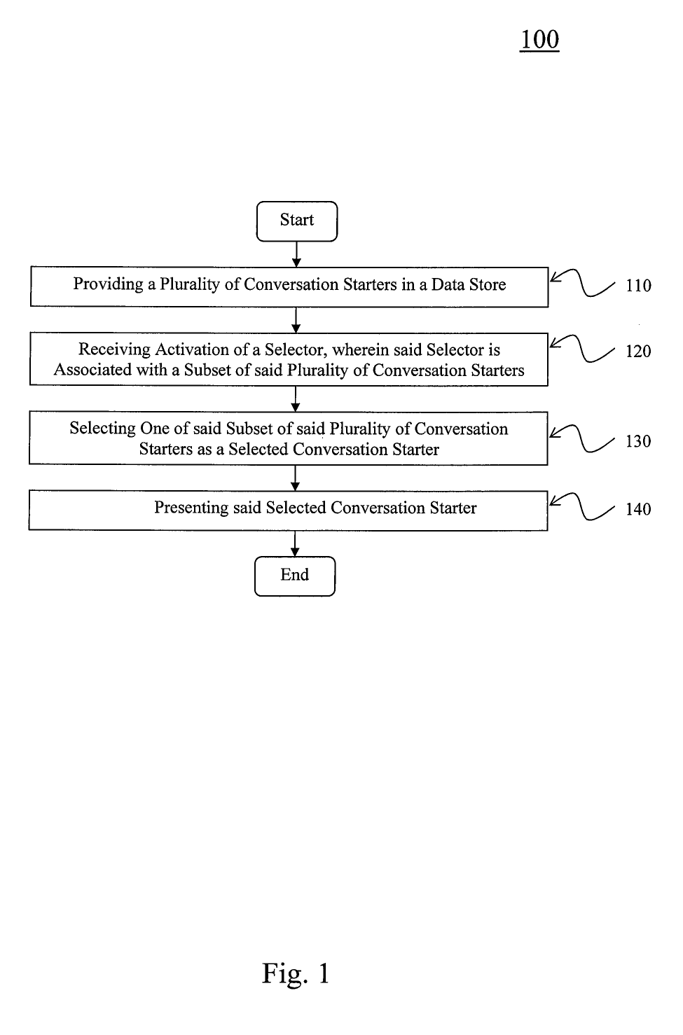

FIG. 1 is a flow diagram illustrating a method of facilitating conversation or stimulating though, in accordance with one embodiment of the present invention. For purposes of illustration only, the method is described as facilitating conversation between two individuals for purposes of conveying values held by one individual to another individual. For instance, the method may facilitate conversation between a parent and a child for purposes of conveying values held by the parent to the child. However it is contemplated that the method outlined in FIG. 1 is able to facilitate conversation between any two or more individuals, or to stimulate thought for one or more individuals.

In one embodiment, the systems and methods for facilitating conversation can be used to convey faith-based values. For instance, the systems and methods can be used to facilitate conversations using conversation starters that are designed to convey faith based values held by the parent to the child. That is, the conversation starters are designed to touch on a specific faith-based topic, not through direct religious discourse (e.g., discussion on topics raised by the Bible), but through discussions on personal experiences and thoughts of the parent that are indirectly related to faith-based topics. In that manner, the conversation starters help the parent to open discussion on various faith-based topics.

As shown in FIG. 1, a plurality of conversation starters is provided in a data store 110. In general, the data store maintains, or stores, and provides access to the plurality of conversation starters. In one embodiment, the data store is integrated within a device for facilitating conversation, such as internal memory for storing the conversation starter in a format suitable for later presentation to a user. In another embodiment, the data store is peripheral to the device for facilitating conversation. For instance, the data store is peripheral memory (e.g., flash memory, etc.) that is inserted into the device. In another example, the data store is remote from the device, but accessible by the device through a communication network (e.g., interne).

The conversation starters are designed to begin or facilitate conversation, or stimulate thought. In one embodiment, the conversation starter comprises a question posed to one or more users. In another embodiment, the conversation starter comprises an instruction that is posed to one or more users. In still another embodiment, the conversation starter comprises a statement. Still other forms of conversation starters are contemplated in other embodiments.

Access to a conversation starter is through a selector, in one embodiment. For instance, activation of the selector is received 120 to indicate that a user is requesting a conversation starter. In one example, the selector is a button, which upon activation is received to indicate that a conversation starter is requested. Other implementations are contemplated for requesting a conversation starter.

The selector is associated with a subset of the plurality of conversation starters. For instance, the plurality of conversation starters is partitioned into one or more groupings or categories of conversation starters, wherein a conversation starter in a category is accessible through a corresponding selector. In one implementation, these categories are related under a common theme, such that the plurality of conversation starters is grouped under a common theme, such as a “Faith Based” theme. As such, the grouping of categories under the theme provides for a further partitioning of conversation starters.

In another embodiment, the subset is the entirety of the plurality of conversation starters. As such, all of the conversation starters are grouped or related under a common theme, or are grouped or related under a category under a common theme. In another implementation, the conversation starters are not necessarily related under a common theme or category under a theme, but are still designed to facilitate conversation, or stimulate thought on a variety of topics.

Upon activation of the selector, one of the subset of the plurality of conversation starters is selected 130 and accessed. Thereafter, the selected conversation starter is thereafter presented to the user 140. In that way, the conversation starter is used to facilitate conversation between one or more users.

In addition, a second selector is associated with a second subset of the plurality of conversation starters, in another embodiment. Upon activation of the second selector, one of the second subset of the plurality of conversation starters is selected and accessed, as a second selected conversation starter. Thereafter, the second selected conversation starter is presented to the user.

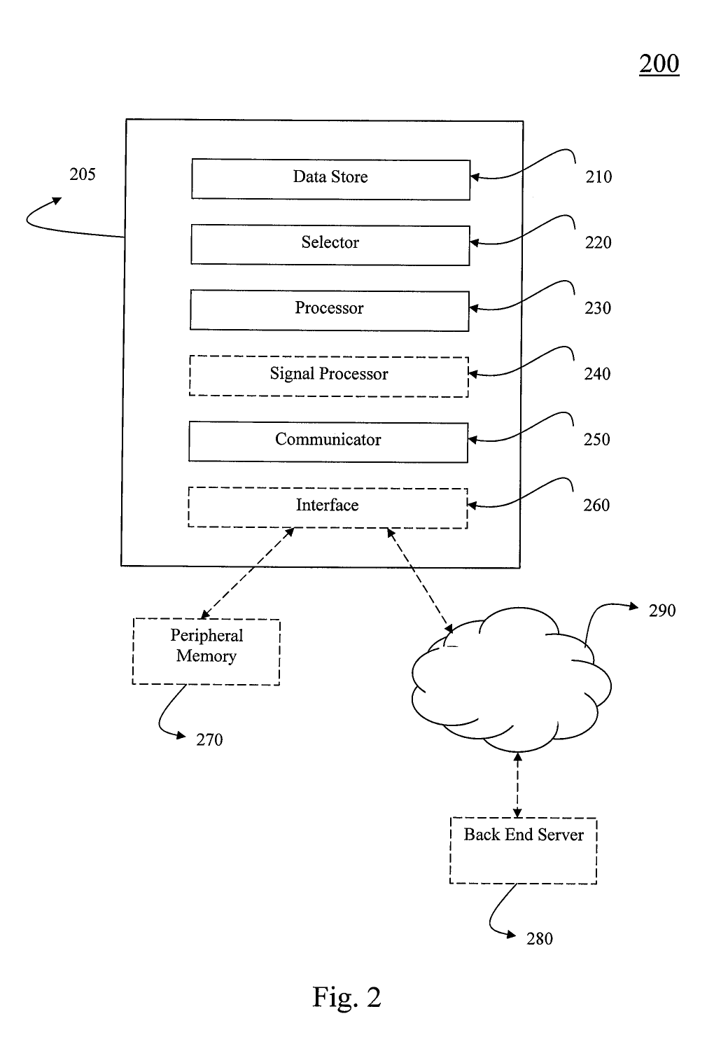

FIG. 2 is an illustration of a system 200 for facilitating conversation or stimulating thought, in accordance with one embodiment of the present invention. The system 200 includes a device 205 that is configured to facilitate conversation or stimulate thought. As described previously, device 205 can be a portable device (e.g., a dedicated device, mobile phone, handheld device, portable computer, etc.), or a less portable device (e.g., desk-top computer, multi-functional television, etc.).

In one embodiment, the system 200 comprises a portable device 205 that is configured to facilitate conversation or stimulate thought. The portable device 205 is shaped and configured to fit comfortably within the hand of an individual. In addition, the portable device 205 is sized for convenient handling and portability. For instance, the device 205 can be easily stored in a handbag, a pocket (shirt, pant, or coat, etc.). Also, the device 205 is sized for convenient storage in various storage places, such as drawers, table tops, pockets or compartments found in a vehicle, etc. In that manner, the device 205 is readily available for interaction with a user no matter where the user is located. As such, the device 205 is shaped and sized to be conveniently located anywhere the user may be located, and configured for immediate interaction and presentation of a conversation starter.

Device 205 includes a data store 210 for storing a plurality of conversation starters. In one implementation, the conversation starters are associated with a theme, and as such, device 205 provides theme based conversation starters. For instance, the plurality of conversation starters may be related to a faith based theme, where each of the conversation starters has roots in some faith-based teaching (e.g., story, fact, rule, news, issues, moral, etc.). Other themes may include groupings of conversation starters relating to sports, world and country history, trivia, any learning material (e.g., math, foreign language, etc.), family history, etc.

Also, each plurality of conversation starters relating to a theme may be further partitioned into various categories, wherein each category provides a further and narrower grouping of conversation starters.

In one embodiment, data store 210 is fully integrated within device 205. For instance, the plurality of conversation starters is stored in data store 210 within device 205. In that manner, device 205 acts as a dedicated device maintaining and presenting the plurality of conversation starters as per user request.

In one embodiment, the plurality of conversation starters is fully stored in data store 210. In another embodiment, some of the plurality of conversation starters are stored in data store 210, and the remaining conversation starters are stored in secondary storage (e.g., peripheral memory), as will be described below.

In another embodiment, device 205 is configurable to change its association with or editing of the conversation starters. More specifically, some or all of the plurality of conversation starters in data store 210 can be substituted, modified, updated, or removed. In addition, the plurality of conversation starters as a group can be augmented (in that new conversation starters can be added to the plurality), entirely replaced, changed, updated, or removed.

Processor 230 is used for editing conversation starters associated with device 205 for purposes of coordinating access to data store 210, and editing conversation starters in data store 210. In addition, interface 260 is used to access additional conversation starters for purposes of editing the plurality of conversation starters associated with device 205. For instance, conversation starters located at a back-end server 280 are accessible through a communication network 290 (e.g., internet) using interface 260. Also, conversation starters located in peripheral memory 270 are directly accessible through interface 260. Interface 260 can be any type of interface suitable for facilitating interaction between devices, and more specifically for providing access to peripherally located or remotely located conversation starters, such as a communication bus, a universal serial bus (USB), other communication ports, input/output interfaces, etc.

In particular, the plurality of conversation starters is stored in data store 210, or in peripheral memory 270, or a combination of both. More specifically, optional interface 260 provides access to peripheral memory 270, within which is stored one or more conversation starters. The use of peripheral memory 270 allows greater flexibility for device 205 in that conversation starters in peripheral memory 270 can be used to replace entirely the plurality of conversation starters associated with device 205 in association with a new or same theme, augment the plurality of conversation starters associated with a theme such that new conversation starters are added to the plurality of conversation starters, or modify existing conversation starters in the plurality of conversation starters by providing the most current conversation starter in substitution of an older conversation starter.

In another embodiment, conversation starters are not stored in data store 210, but are stored entirely in peripheral memory 270. For illustration purposes only, peripheral memory 270 could be flash memory capable of being inserted into device 270. The peripheral memory 270 includes the plurality of conversation starters of a theme. Additionally, the plurality of conversation starters included within the peripheral memory 270 can be edited, such that conversation starters may be added, removed, or modified consistent with a current theme. In this case, data store 210 may not be included in device 205 for storing conversation starters, or may be used to store a working group of conversation starters used primarily for trial purposes, so that a user can sample at least one conversation starter for the device 205.

Further, the plurality of conversation starters may be entirely substituted with another plurality of conversation starters associated with a second theme. For instance, processor 230 and interface 260 may be used to communicate a second plurality of conversation starters associated with the second theme. The second plurality of conversation starters may be stored in a back end server and accessed through a communication network, or may be stored in a device that is coupled to device 205. In another instance, a second peripheral memory may be newly inserted in place of a first peripheral memory storing a first plurality of conversation starters, wherein the second peripheral memory includes a second plurality of conversation starters that is associated with its own theme. As such, device 205 takes on a new personality, now being associated with a new theme of conversation starters supported by the second plurality of conversation starters.

Device 205 includes one or more selectors, such as selector 220. Each selector is associated with a subset of the plurality of conversation starters. The subset is associated with a category of conversation starters consistent with the theme. In one case, the theme only includes one category, or the theme is the category. In another case, two or more categories are consistent with the theme.

In one embodiment, selector 220 is a physical or mechanical button. For instance, the button is physically pushed by a user in order to activate the selector. In general, activation of selector 220 provides for a control signal to be generated indicating that selector 220 has been selected by the user. In another embodiment, selector 220 is a virtual button that is selectable through any suitable means. For instance, a virtual button may be a displayed icon to be selected through any suitable means (e.g., touch pad activation, mouse/cursor activation, voice activation, etc.).

One benefit to making a one-to-one association between a selector and a theme is that activating a selector automatically makes a request for a conversation starter in a corresponding category of conversation starters. As such, activation of a first selector of a device 205 indicates a request for a conversation starter in a first category of conversation starters, and activation of a second selector of device 205 indicates a request for a conversation starter in a second category of conversation starters.

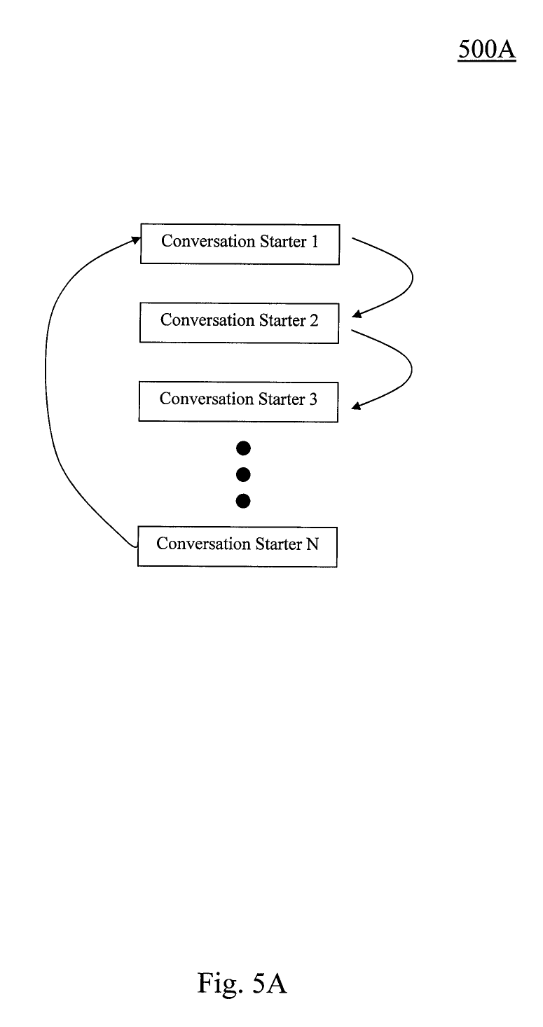

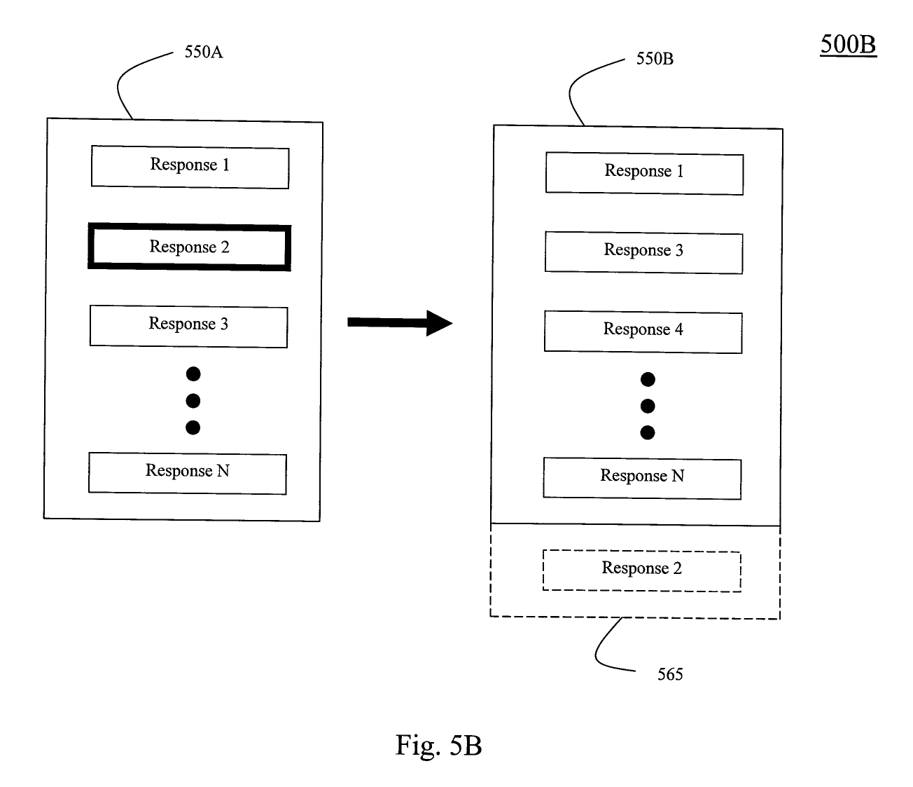

As previously introduced, device 205 includes a processor 230 for receiving activation of the selector 220. Activation is associated with a request for a conversation starter from a corresponding subset of the plurality of conversation starters associated with the selector 220. As such, upon activation processor 230 is capable of selecting one of the subset of conversation starters, as a selected conversation starter. Selection of a conversation starter is achieved through any suitable selection process. Examples of selection processes are described further in relation to FIGS. 5A and 5B.

Another benefit provided in device 205 is that activation of a selector automatically communicates a request for a conversation starter in a corresponding category of conversation starters. More specifically, the request is made even if the device 205 is in an OFF state. For instance, selector 220 is a physical button and can be activated whether device 205 is an ON or OFF state. As such, whenever selector 220 is activated, processor 230 receives the activation, and proceeds to make a selection of a conversation starter.

In one embodiment, the selected conversation starter comprises a question consistent with the category. In another embodiment, the selected conversation starter comprises an instruction consistent with the category. Still other embodiments are envisioned wherein the selected conversation starter comprises a statement, or any suitable form capable of facilitating conversation or stimulating thought.

Also shown in FIG. 2, device 205 includes a communicator 250 for presenting the selected conversation starter to the user. Communicator 250 is able to communicate in any format, or combination of formats, suitable for presenting the selected conversation starter. For instance, communicator 250 is a speaker for presenting the selected conversation starter in audio form. In this case, device 205 may include a signal processor for formatting the selected conversation starter into a suitable format that is compatible with the speaker, such as a digital to analog converter for converting the digitally stored audio signal of the selected conversation starter into an analog waveform compatible with the speaker. In another embodiment, communicator 250 comprises a display for presenting the selected conversation starter in text form. As such, the user would read the selected conversation starter from the display. In other embodiments, a combination of audio and text formats is provided so that the user can hear and read the selected conversation starter. In still other embodiments, other suitable formats for presenting the conversation starter are well supported.

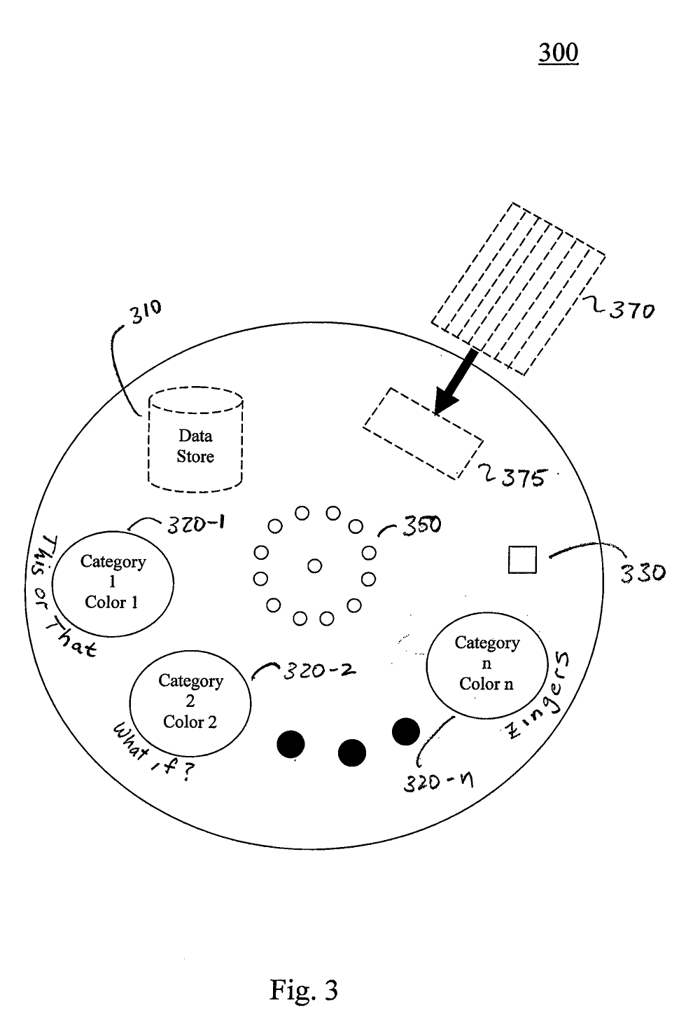

FIG. 3 is an illustration of a portable system 300 for facilitating conversation that includes a speaker for broadcasting conversation starters used to facilitate conversation, in accordance with one embodiment of the present invention. System 300 is configured to be of a size and shape for easy handling and portability, such that it may be carried on or with the user, and once handled fits easily within the palm of a user's hand.

As shown, data store 310 includes a plurality of conversation starters. As previously described, the plurality of conversation starters is associated with a theme, in one implementation, including a non-theme that includes a random collection of conversation starters. In addition, the plurality of conversation starters may be stored in data store 310, or peripheral memory 370, or a combination of both. Peripheral memory 370 is configured to be capable of being inserted into slot 375, and fully integrated into device 300, such that the plurality of conversation starters is available within device 300.

Device 300 also includes one or more buttons 320, each of which is associated with a corresponding subset of the plurality of conversation starters 320. Each button comprises a physical or mechanical button capable of being activated whether device 300 is in an ON or OFF state. A subset defines a category of conversation starters consistent with the overarching theme. As shown in FIG. 3, button 320-1 is associated with a first category of conversation starters, button 320-2 is associated with a second category of conversation starters, and device 300 includes other buttons on up to button 320-n that is associated with an n^{th} category of conversation starters.

For illustration purposes only, the plurality of conversation starters may be associated with a faith-based theme. As such, conversation starters within the faith-based theme are designed to facilitate conversation relating to faith, in a broad sense. Various categories underneath the faith-based theme can also be presented. For instance, some categories provided for illustration include the following: “This or That;” “What if?;” “Favorites;” “Friends & Family;” and “Zingers.” As an example, button 320-1 is associated with the “This or That” category, button 320-2 is associated with the “What if?” category, button 320-3 (not shown) is associated with the “Favorites” category, button 320-4 (not shown) is associated with the “Friends and Family” category, and button 320-n, as the fifth button, is associated with the “Zingers” category. Other categories are supported by device 300.

In the “This or That” category, conversation starters begin by juxtaposing two different choices. In general, the conversation starter may ask the user to choose between two different choices, and to explain the reasoning behind the choice. For instance, some conversation starters under this category and under a faith-based theme may pose the following:
“Are you more like a teddy bear . . . or a polar bear?”;
“Would you rather live to age 35 as a millionaire, or to age 85 as a poor person?”;
“Which is worse: telling a white lie or hurting someone's feelings?”; and
“What do you think is easier for God: showing compassion or judgment?”

The “What If?” category poses conversation starters that spark the imagination. For instance, some conversation starters under this category and under a faith-based theme may pose the following:
“If a cashier gave you too much change, would you give it back?”;
“If you could watch any event in the Bible as it happened, which one would you watch?”;
“If you could find out, would you want to know when and how you'll die?”; and
“If you could spend a day with anyone in the world, who would it be and what would you do?”

The “Favorites?” category poses conversation starters that ask for someone's favorite. For instance, some conversation starters under this category and under a faith-based theme may pose the following:
“Who's your favorite famous person?”;
“What do you think is God's least favorite thing about the world?”;
“What is your favorite holiday?”;
“What is your least favorite family rule?”; and
“What is your favorite Bible story?”

The “Friends and Family?” category poses conversation starters that are related to family members or friends. For instance, some conversation starters under this category and under a faith-based theme may pose the following:
“If you brought a smelly, dirty homeless person home for dinner, how do you think our family would react?”;
“Why did God create families?”;
“What is more important: friends or family?”; and
“What is the most fun you've ever had with our family?”

The “Zingers?” category presents conversation starters that come out of nowhere, or out of left field, to use a baseball analogy. For instance, some conversation starters under this category and under a faith-based theme may pose the following:
“Do you believe in ghosts?”;
“Do you think it's okay to ask God for money?”;
“If you knew you were going to live forever, would it be important for you to be kind to people, and why?”; and
“The Bible says, ‘If you honor your father and mother, you will live a long life.’ If this is true, how long do you think you will live?”

In one embodiment, questions do not overlap between categories. As such, each conversation starter in the plurality of conversation starters is unique. In another embodiment, conversation starters may overlap between categories, in that a conversation starter may be found in one or more categories in a plurality of conversation starters.

In another embodiment, each of the buttons 320 is associated with a unique color. That is, a device includes a plurality of conversation starters that is associated with a theme. A first selector or button is associated with a first subset or category of the plurality of conversation starters, and is further associated with a first color (e.g., button 320-1, category 1, color 1). In addition, a second selector or button is associated with a second subset or category of the plurality of conversation starters, and is further associated with a second color (e.g., button 320-1, category 2, color 2). This relationship is repeatable for any number of buttons. For instance, continuing with the example provided above, button 320-1 of the “This or That” category is associated with color 1, such as green; button 320-2 of the “What if?” category is associated with color 2, such as orange; button 320-3 (not shown) of the “Favorites” category is associated with color 3, such as blue; button 320-4 (not shown) of the “Friends and Family” category is associated with color 4, such as purple; and button 320-n, as the fifth button, of the “Zingers” category is associated with color n, such as yellow.

The association between color and category is beneficial for recognizing a specific category by color. While in some embodiments the categories are labeled in text form directly on device 300 in relation to corresponding buttons, in order to read the text, device 300 must be oriented in a specific manner to allow for the user to easily recognize the letters in the text. That is, device 300 must be turned such that the letters are presented to the user in a readable orientation, e.g., right side up. This may entail turning device 300 until the text is oriented correctly.

On the other hand, by associating a specific category with a specific color, no matter how device 300 is oriented, a button is recognizable by its color. As such, if the user is interested in the “This or That” category, and knows that category is associated with the color green, then the user need only visually locate the green button, button 320-1 in the example provided above, instead of having to correctly orient device 300 in order to read the label “This or That” signifying button 320-1. In another embodiment, by lighting up each of the buttons 320, device 300 is easily used in low light conditions since the colors of the buttons are lit and visible. In still other embodiments, categories are associated with other distinguishing features. For instance, the shape of a button may define its category.

In still another embodiment, a color signifies a corresponding category no matter the device. For instance, a first device is associated with a first theme of conversation starters. The first device includes a selector of a certain, first color that is associated with a category. In addition, a second device is associated with a second theme of conversation starters. The second device also includes a selector of the first color that is associated with the same category. As such, the color of the selector signifies a particular category of conversation selectors, and is consistent throughout one or more devices.

Also shown in FIG. 3 is a speaker 350 for presenting the selected conversation starter in audio form. Device 300 is configured to present a conversation starter in a manner that requires minimal user interaction. Based on the selection of a single selector button, a selected conversation starter is presented through speaker 350, and the user need only listen to the audio playback of the selected conversation starter. As a result, one or more users may simultaneously listen to the selected conversation starter, and immediately begin a discussion stemming from the conversation starter.

Device 300 also includes a repeat button 330. Activation of repeat button 330 communicates a request to present the latest conversation starter through speaker 350. For instance, if a user did not catch the first presentation of the selected conversation starter, through the activation of the repeat button 330, device 300 will replay the last conversation starter selected in presenting the selected conversation starter.

In another embodiment, device 300 also includes a display for presenting the selected conversation starter in text form. The display may augment the speaker 350, or may entirely substitute the speaker 350.

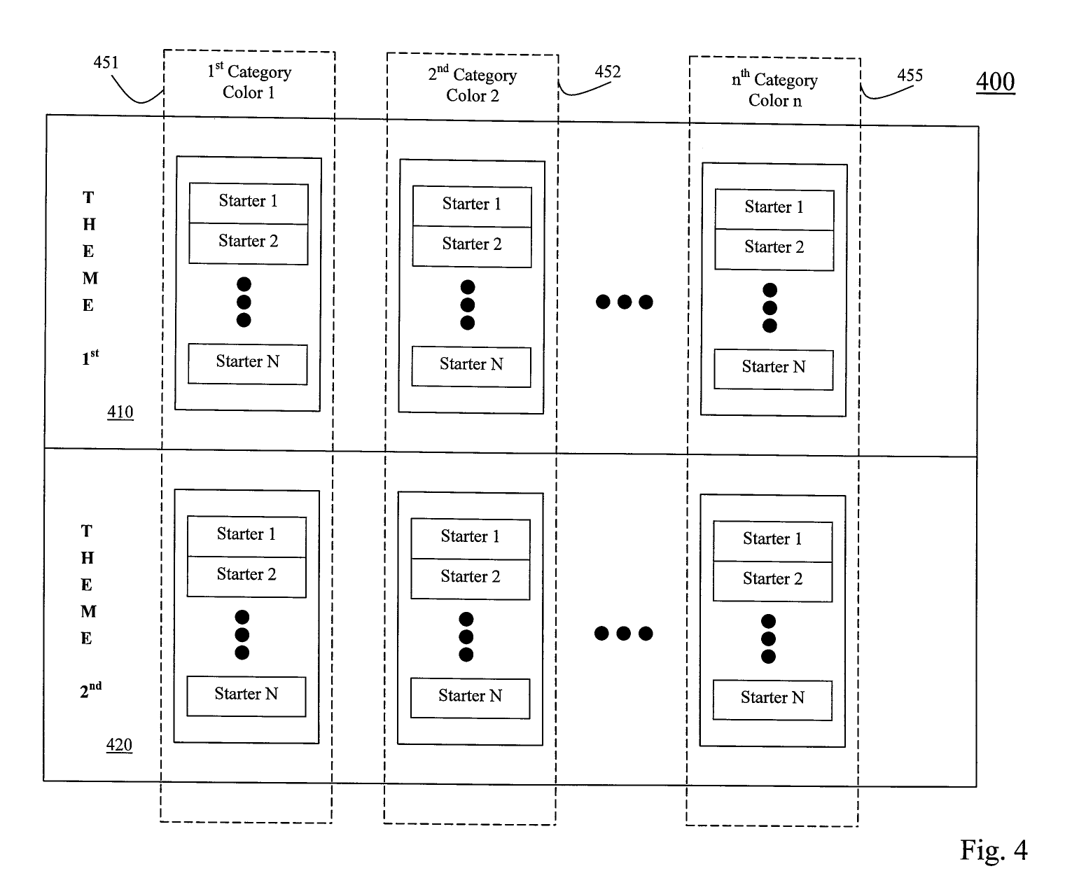

FIG. 4 is an illustration of how categories are applicable across multiple themes of conversation starters accessible through a common device, in accordance with one embodiment of the present invention. For instance, a portable system for facilitating conversation is capable of appropriating one or more themes of conversation starters, wherein each theme includes one or more categories of conversation starters, and wherein each category of conversation starters is applicable across multiple themes. Additionally, if the categories are associated with corresponding colors, each of the categories and their corresponding colors are applicable across multiple themes.

As shown in FIG. 4, the portable system includes a first plurality of conversation starters 415 of a first theme 410. The first theme 410 of conversation starters is further partitioned into categories: the first category 451 that is associated with color 1; the second category 452 associated with color 2, on up to the n^{th} category 455 associated with color n. Each category in the first theme 410 is a subset of the first plurality of conversation starters 415, and includes one or more conversation starters 1-N.

Also shown in FIG. 4, the portable system includes a second plurality of conversation starters 425 of a second theme 420. The system may include the second plurality of conversation starters 425 exclusively, or may include both the first and second plurality of conversation starters for access. The second theme 420 of conversation starters is further partitioned into the same categories listed above: the first category 451 that is associated with color 1; the second category 452 associated with color 2, on up to the n^{th} category 455 associated with color n. Each category in the second theme 420 includes one or more conversation starters 1-N that is a subset of the second plurality of conversation starters 425.

For illustration, FIGS. 3 and 4 in combination illustrate the application of categories across different themes of conversation starters. Device 300 may include a first plurality of conversation starters that is associated with a first theme 410 (e.g., faith-based) of conversation starters. As shown in FIG. 3, consistent with the first theme, button 320-1 is associated with a first category 451 (e.g., “This or That”), that is further associated with a first color (e.g., green). The first category 451 includes a subset of the first plurality of conversation starters 415 accessible through button 320-1.

At a different point in time, device 300 may be configured to include and access a second plurality of conversation starters 425 that is associated with a second theme 420 (e.g., world politics). That is, instead of accessing the first theme 410 of conversation starters, device 300 now is configured to access the second theme 420 of conversation starters. Device 300 still includes buttons 320, each of which are still associated with corresponding categories and colors that do not change from theme to theme. Consistent with the second theme 420 of conversation starters, button 320-1 is still associated with the first category 451 (e.g., This or That”), and is still associated with the first color (e.g., green). However, the same category now references a subset of the second plurality of conversation starters 425 that is consistent with the second theme 420. As such, the category 451 for button 320-1 remains the same and is applicable across multiple themes for device 300.

FIGS. 5A and 5B are illustrations of processes used for selecting a conversation starter, in accordance with embodiments of the present invention. Embodiments of the present invention are not limited to the selection processes outlined in FIGS. 5A and 5B, and can support any process for selecting conversation starters from a plurality of conversation starters, or more specifically a subset or category of conversation starters.

FIG. 5A is an illustration of the sequential selection of a conversation starter from a pool of conversation starters 500 that is sequentially ordered, in accordance with one embodiment of the present invention. As an example, the conversation starters are to be selected from a category of conversation starters associated with a plurality of conversation starters related by a theme.

As shown, in response to the activation of a corresponding selector (e.g., button), the next conversation starter following the last selected conversation starter is selected. For instance, the very first time a request for a conversation starter in the pool of conversation starters 500 is made, a pre-selected conversation starter is selected and presented, such as the first in the sequence, conversation starter 1. The next time a request is made for a conversation starter from the pool 500, the next conversation starter in the sequence following conversation starter 1 is selected, which is conversation starter 2.

The pool of conversation starters 500 may be comprised of a finite number of conversation starters. As such, the sequence of conversation starters returns to the first conversation starter in a loop after reaching the last or N^{th} conversation starter. That is, after selection of the last conversation starter N, the next time a request is made for a conversation starter from the pool 500, the next conversation starter selected is the first conversation starter 1.

FIG. 5B is an illustration of the random selection of a conversation starter from a selectable pool 550 of conversation starters, in accordance with one embodiment of the present invention. The selectable pool of conversation starters 550 includes conversation starters from a category of conversation starters, wherein the category includes N conversation starters. Selectable pool 550 decreases in size as conversation starters are selected.

To the left of FIG. 5B, the selectable pool 550A includes all of the category of conversation starters, such as in a default state when no requests have been made for a conversation starter from the category. As shown in FIG. 5B, conversation starter 2 has been selected from the selectable pool 550A. In an effort to reduce the possibility of repeat selections of a particular conversation starter over a period, the selected conversation starter 2 is removed from the newly created selectable pool 550B when performing the next selection of a conversation starter.

Also, conversation starter 2 is placed into an idling pool 565 for a period of time. In one implementation, conversation starter 2 is placed into the idling pool 565 until selectable pool 550 is empty. Thereafter, all of the conversation starters are again placed back into the selectable pool 550. In another implementation, conversation starter 2 is placed into the idling pool 565 for a period of time, such as for x selections (e.g., x=10) of conversation starters. As such, after x more conversation starters have been selected, conversation starter 2 is then added back into the selectable pool 550 such that it is eligible for selection.

### 3. Conversation Starters as an Extension of Learning Material

A device for facilitating conversation is linked to other supplementable material, in accordance with one embodiment of the present invention. That is, the plurality of conversation starters accessible through the device acts as an extension to accompanying material, such as course or learning material, textbooks, etc.

Supplementable material is provided in relation to a structured class or course, in one embodiment. For example, the structured class is Sunday School provided in conjunction with a particular religion. The Sunday School may have a curriculum supported by supplementable material, such as course materials, teachers guide books, lecture materials, etc. As other examples, supplementable material may include a book, lecture, video, movie, audio program, or any other type of material suitable for conveying information.

As such, the plurality of conversation starters associated with the device is designed to facilitate conversation in relation to the supplementable material. For instance, a conversation starter may be designed to further discussion and understanding on a particular subject covered in the supplementable material. Also a group of conversation starters may be designed to lead a discussion on the same subject along on a path in an effort to guide participants towards an understanding of the subject.

Accordingly, embodiments of the present invention provide for a system and method for facilitating conversation. Embodiments of the present invention provide a easily handled portable device that facilitates conversation through the selection of one button. In another embodiment, conversation starters accessible through the portable device aid parents in holding discussions that help to pass on family values to their children.

A system and method for facilitating conversation, such as between a parent and a child for purposes of conveying values held by the parent to the child, is thus described. While the invention has been illustrated and described by means of specific embodiments, it is to be understood that numerous changes and modifications may be made therein without departing from the spirit and scope of the invention as defined in the appended claims and equivalents thereof. Furthermore, while the present invention has been described in particular embodiments, it should be appreciated that the present invention should not be construed as limited by such embodiments, but rather construed according to the below claims.

What is claimed:

1. A method for engaging conversation, comprising:
providing a plurality of conversation starters in a data store;
receiving activation of a selector, wherein said selector is associated with a subset of said plurality of conversation starters;
selecting one of said subset of said plurality of conversation starters as a selected conversation starter; and
presenting said selected conversation starter.

2. The method of claim 1, further comprising:
presenting said selected instruction in audio form.

3. The method of claim 1, further comprising:
presenting said selected instruction in text form.

4. The method of claim 1, wherein said selecting one of said subset further comprises:
sequentially selecting the next conversation starter as said selected conversation starter in said subset, wherein conversation starters in said subset are ordered sequentially.

5. The method of claim 1, wherein said selecting one of said subset further comprises:
randomly selecting a new conversation starter as said selected conversation starter without repeating a conversation starter over a history of selected conversation starters.

6. The method of claim 1, further comprising:
receiving activation of a second selector, wherein said second selector is associated with a second subset of said plurality of conversation starters; and
selecting one of said second subset of said plurality of conversation starters as a second selected conversation starter; and
presenting said second selected conversation starter.

7. The method of claim 1, further comprising:
associating said plurality of conversation starters with a theme; and
associating said subset of said plurality of conversation starters with a category of said theme.

8. The method of claim 7, further comprising:
configuring said plurality of conversation starters as faith based conversation starters, wherein said theme comprises a faith based theme.

9. The method of claim 7, further comprising:
receiving a second plurality of conversation starters that are associated with a second theme;
storing said second plurality of conversation starters in said data store;
associating a second subset of said second plurality of conversation starters with said category, wherein said category is applicable across themes;
receiving activation of said selector, wherein said selector is associated with said second subset of said second plurality of conversation starters;
selecting one of said second subset of said plurality of conversation starters as a second selected conversation starter; and
presenting said second selected conversation starter.

10. The method of claim 7, further comprising:
receiving a second plurality of conversation starters;
storing said second plurality of conversation starters in said data store; and
supplementing said plurality of conversation starters with said second plurality of conversation starters.

11. A handheld device for engaging conversation, comprising:
a data store for storing a plurality of conversation starters, wherein said plurality of conversation starters is associated with a theme;
a selector associated with a subset of said plurality of conversation starters, wherein said subset is associated with a category of conversation starters consistent with said theme;
a processor for receiving activation of said selector, and for selecting one of said subset of said plurality of conversation starters as a selected conversation starter; and
a communicator for presenting said selected conversation starter.

12. The device of claim 11, wherein said communicator comprises a speaker for presenting said selected conversation starter in audio form, and said device further comprises:
a signal processor for formatting said selected conversation starter to a format compatible with said speaker.

13. The device of claim 11, wherein said communicator comprises a display for presenting said selected conversation starter in text form.

14. The device of claim 11, wherein said selector comprises a physical button.

15. The device of claim 11, wherein said selector comprises a virtual button.

16. The device of claim 11, wherein said processor receives said activation when said handheld device is in an OFF state.

17. The device of claim 11, wherein said selected conversation starter comprises a question consistent with said category.

18. The device of claim 11, wherein said selected conversation starter comprises an instruction consistent with said category.

19. The device of claim 11, further comprising:
a color associated with said category, wherein said selector is presented with said color.

20. The device of claim 19, further comprising:
a second selector associated with a second subset of said plurality of conversation starters, wherein said second subset is associated with a second category of conversation starters consistent with said theme; and
a second color associated with said second category, wherein said second color is presented with said second color.

21. The device of claim 11, further comprising:
an interface for receiving a second plurality of conversation starters associated with a second theme, wherein said selector is associated with a subset of said second plurality of conversation starters that is associated with said category of conversation starters consistent with said second theme, wherein said category is applicable across multiple themes.

22. The device of claim 21, wherein said category is taken from a group consisting essentially of:
“This or That;”
“What if?;”
“Favorites;”
“Friends & Family;” and
“Zingers.”

23. The device of claim 21, wherein said interface comprises a communication port for connecting to a back end server through a communication network.

24. The device of claim 21, wherein said interface comprises a port for coupling memory.

25. A handheld device for engaging conversation, comprising:
an interface for communicatively coupling with peripheral memory;
a processor for communicating with a peripheral memory that is coupled to said interface, and for accessing a plurality of conversation starters stored in said peripheral memory, wherein said plurality of conversation starters is associated with a theme;
a selector associated with a subset of said plurality of conversation starters, wherein said subset is associated with a category of conversation starters consistent with said theme;
wherein said processor is for receiving activation of said selector, and for selecting one of said subset of said plurality of conversation starters as a selected conversation starter; and
a communicator for communicating said selected conversation starter to a user.

26. The device of claim 25, further comprising:
wherein said communicator comprises a speaker for broadcasting said selected conversation starter; and
a signal processor for formatting said selected conversation starter into a format compatible with said speaker.

27. The device of claim 25, wherein said communicator comprises a display for displaying said selected conversation starter in text form.

28. The device of claim 27, further comprising:
a second selector associated with a second subset of said plurality of conversation starters, wherein said second subset is associated with a second category of conversation starters consistent with said theme; and
wherein said processor is for receiving activation of said second selector, and for selecting one of said second subset as a second selected conversation starter.
